(19) United States
(12) Patent Application Publication
(10) Pub. No.: US 2017/0209872 A1
(43) Pub. Date: Jul. 27, 2017

(54) DUST REMOVAL APPARATUS

(71) Applicant: Joong Soon KIM, Anyang-si (KR)

(72) Inventor: Joong Soon KIM, Anyang-si (KR)

(21) Appl. No.: 15/427,043

(22) Filed: Feb. 7, 2017

Related U.S. Application Data
(63) Continuation of application No. PCT/KR2015/008288, filed on Aug. 7, 2015.

(30) Foreign Application Priority Data
Aug. 8, 2014 (KR) 10-2014-0102349

(51) Int. Cl. B03C 7/06

(52) U.S. Cl. CPC B03C 7/06

(57) ABSTRACT

The present invention relates to a dust removal apparatus and, more specifically, to a dust removal apparatus preventing a raw material from absorbing water when coming into contact with the outside air by separating the raw material from dust through an electrical reaction.

### CROSS-REFERENCES TO RELATED APPLICATIONS

This Application claims the benefit of priority and is a Continuation application of the prior International Patent Application No. PCT/KR2015/008288, with an international filing date of Aug. 7, 2015, which designated the United States, and is related to the Korean Patent Application No. 10-2014-0102349, filed Aug. 8, 2014, the entire disclosures of all applications are expressly incorporated by reference in their entirety herein.

### BACKGROUND OF THE INVENTION

1. Field of the Invention

The present invention relates to a dust removal apparatus, and more particularly to an apparatus for removing dust included in a raw material.

2. Description of Related Art

Generally, in apparatuses for removing a foreign substance included in a raw material, a method of separating the foreign substance from the raw material by forced air has widely been used.

However, such a forced air blowing method requires a large amount of electric power to continuously generate wind, and it is disadvantageous in that a raw material contacts external air and thus vapor included in air intaked from the outside permeates the raw material.

As illustrated in FIG. 1, a foreign material separator includes a recycled raw material supplier 10 to supply a recycled raw material, a dust separator 11 to remove a foreign material from the recycled raw material supplied from the recycled raw material supplier 10, and a recycled raw material storage unit 12 to collect the recycled raw material from which the foreign material has been removed in the dust separator 11.

In addition, the dust separator 11 includes: a main body 16 having a cylindrical shape and including a recycled raw material inlet 13 disposed at an upper side, a foreign material outlet 14, and a recycled raw material outlet 15 disposed at a lower side; a recycled raw material induction tube 17 extending to a certain length from the recycled raw material inlet 13 and disposed along a central axial line of an inside of the main body to induce a recycled raw material downward; a high-pressure air blowing pipe 18 disposed below the recycled raw material induction tube 17 at a position facing a lower exit thereof to remove a foreign material included in the recycled raw material by applying air-blowing pressure to the recycled raw material dropping downward; and an external high-pressure air blower 19 connected to the high-pressure air blowing pipe 18.

The foreign material separator can separate various foreign materials due to the velocity of air discharged from the external high-pressure air blower 19, but consumes a large amount of electric power to continuously operate the high-pressure air blower 19. In addition, external air is introduced into the foreign material separator and thus moisture permeates the raw material, resulting in problems with the quality of a product produced from the raw material.

### RELATED ART DOCUMENT

### Patent Document

(Patent document 1) Korean Patent Publication No. 2011-0027049

### BRIEF SUMMARY OF THE INVENTION

Therefore, the present invention has been made in view of the above problems, and it is one object of the present invention to provide a dust removal apparatus that minimizes energy consumed for dust removal and prevents moisture from permeating a raw material.

In accordance with one aspect of the present invention, provided is a dust removal apparatus 1000 including: a main body 100 including a transfer path 110 opening from an upper end to a lower end thereof; a dust discharger 120 extending from a one side of the transfer path 110 to a side surface of the main body 100; and an adsorbing unit 130 disposed at a position connecting the transfer path 110 to the dust discharger 120 to adsorb a raw material 1 and dust 2 moving from the upper end to the lower end of the transfer path 110, wherein the adsorbing unit 130 includes an electrifying unit 131 to electrically charge the raw material 1 and the dust 2, a roller 132 to adsorb the charged raw material 1 and the charged dust 2 by electrical attraction while rotating, and a first ion generator 121 to release ions to the dust 2 adsorbed on the roller 132 and thus detach the dust 2 therefrom.

In addition, the roller 132 is surrounded by an inner wall of the main body 100 and face the electrifying unit 131 to form an electrifying path 110-2, the electrifying unit 131 being configured such that a one side thereof is spaced apart from an outer circumferential surface of the roller 132 by a distance limiting introduction of the raw material 1 into the dust discharger 120 and the other side thereof is spaced apart from the outer circumferential surface of the roller 132 by a distance allowing transfer of the raw material 1 and the dust 2, and the first ion generator 121 is provided at an entrance of the dust discharger 120 through which the dust 2 detached from the roller 132 is introduced into the dust discharger 120.

In addition, the dust removal apparatus 1000 includes a raw material storage unit 200 to store a raw material discharged from the transfer path 110, a dust storage unit 300 to store dust discharged from the dust discharger 120, and a connection part 140 connecting the dust discharger 120 to the dust storage unit 300, wherein the connection part 140 includes an air amplifier 141 to suck external air and transfer the external air to the dust storage unit 300.

In addition, the main body 100 includes an air inlet 150 provided at a lower end of the dust discharger 120 and spaced apart therefrom, the air inlet 150 connecting an outside of the main body 100 to an entrance of the dust discharger 120, and the air amplifier 151 sucks, from the outside, air for transferring the dust 2 detached from the roller 132 to the dust storage unit 300, in cooperation with the air inlet 150.

In addition, the main body 100 may further include a controller 111 to control an amount of the raw material 1, including the dust 2, introduced from the transfer path 110 to the adsorbing unit 130.

In addition, the main body 100 includes a power unit 160 to transfer power to the controller 111 and the roller 132, the power unit 160 comprising a power transmitting member 161 connecting the controller 111 and the roller 132 to transfer power thereto.

In addition, the electrifying unit 131 includes a discharge electrode 131-1 to emit a large amount of electrons to resin and dust and a high-pressure pulse generator 131-2 to supply a high-pressure pulse to the discharge electrode 131-1.

In addition, the transfer path 110 is provided with a second ion generator 112 at a lower end thereof to remove an electric charge of the raw material 1 detached from the roller 132.

In addition, the roller 132 rotates in a direction in which the raw material 1 and the dust 2 move through the transfer path 110, and the raw material 1 adsorbed on the roller 132 contacts an inner wall of the main body 100 formed between a lower portion of the transfer path 110 and the dust discharger 120 and thus is detached thereby from the roller 132.

As is apparent from the fore-going description, the present invention advantageously provides a dust removal apparatus including a rubber roller having an electrostatic attraction force and an electrifying member in order to remove a raw material and dust.

Thus, the dust removal apparatus according to the present invention consumes a smaller amount of power than that consumed in an existing dust removal apparatus in which forced air must be continuously blown to continuously classify a raw material and dust.

In addition, unlike an existing dust removal method wherein forced air is blown by introducing external air to separate a raw material and dust and thus the raw material absorbs moisture contained in the external air and, consequently, the raw material from which moisture has been removed by a dryer contains moisture again, a path through which a raw material moves is blocked from the outside and thus exposure of the raw material dried by a dryer to external moisture is minimized.

Accordingly, deterioration of quality of products due to moisture permeating the raw material is prevented and re-drying of the raw material is not required.

In addition, unlike an existing apparatus in which, when more than a certain amount of raw materials used for production of products is stored in a raw material storage unit, an operator must stop a dust removal apparatus or must empty the raw material storage unit after stopping, a sensor included in a raw material storage unit controls a motor to adjust the amount of a raw material used for production, and thus, labor consumption needed for maintenance of the dust removal apparatus according to the present invention may be minimized.

As is apparent from the fore-going description, the present invention advantageously provides a dust removal apparatus including a rubber roller having an electrostatic attraction force and an electrifying member in order to remove a raw material and dust.

Thus, the dust removal apparatus according to the present invention consumes a smaller amount of power than that consumed in an existing dust removal apparatus in which forced air must be continuously blown to continuously classify a raw material and dust.

In addition, unlike an existing dust removal method wherein forced air is blown by introducing external air to separate a raw material and dust and thus the raw material absorbs moisture contained in the external air and, consequently, the raw material from which moisture has been removed by a dryer contains moisture again, a path through which a raw material moves is blocked from the outside and thus exposure of the raw material dried by a dryer to external moisture is minimized.

Accordingly, deterioration of quality of products due to moisture permeating the raw material is prevented and re-drying of the raw material is not required.

In addition, unlike an existing apparatus in which, when more than a certain amount of raw materials used for production of products is stored in a raw material storage unit, an operator must stop a dust removal apparatus or must empty the raw material storage unit after stopping, a sensor included in a raw material storage unit controls a motor to adjust the amount of a raw material used for production, and thus, labor consumption needed for maintenance of the dust removal apparatus according to the present invention may be minimized.

### BRIEF DESCRIPTION OF THE DRAWINGS

FIG. 1 is a perspective view of a conventional dust removal apparatus;

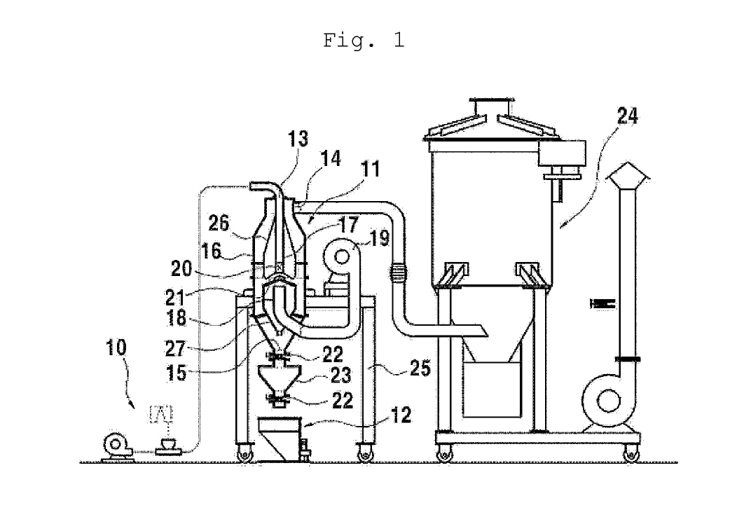

FIG. 2 is an overall perspective view of a dust removal apparatus according to the present invention;

FIG. 3 is a cross-sectional view of a dust removal apparatus according to the present invention; and

FIG. 4 is a cross-sectional view of a dust removal apparatus according to the present invention (When a roller is grounded and thus used as an electrifying body).

FIG. 5 is a cross-sectional view of a dust removal apparatus according to the present invention (When a roller is grounded and thus inserted, or a roller absorbs the raw material and the dust).

### DETAILED DESCRIPTION OF THE INVENTION

Hereinafter, a dust removal apparatus 1000 according to the present invention will be described in detail with reference to the accompanying drawings.

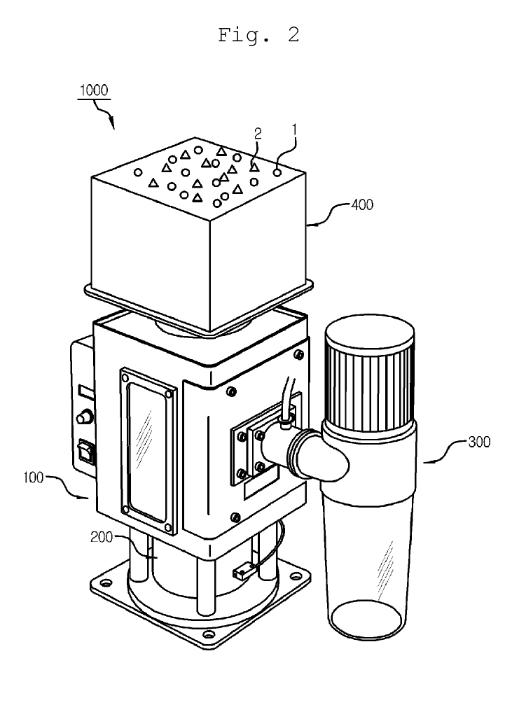

FIG. 2 is an overall perspective view of a dust removal apparatus 1000 according to the present invention.

The dust removal apparatus 1000 includes a main body 100, a raw material storage unit 200, a dust storage unit 300, and a dryer 400.

Referring to FIG. 2, the dust removal apparatus 1000 includes: the main body 100 to independently separate and discharge a raw material 1 and dust 2; the dryer 400 disposed at an upper end of the main body 100 to dry the raw material 1 including the dust 2; the raw material storage unit 200 disposed at a lower end of the main body 100 to store the raw material 1 separated from the main body 100; and the dust storage unit 300 disposed at a side surface of the main body 100 to store the dust 2 separated from the main body 100.

In particular, the raw material 1 including the dust 2 is stored in the dryer 400, the dryer 400 dries the raw material 1 and the dust 2 and introduces the same into the main body 100, and the main body 100 separates the raw material 1 and the dust 2 that are introduced from the dryer 400 and discharges the raw material 1 and the dust 2 to the raw material storage unit 200 and the dust storage unit 300, respectively.

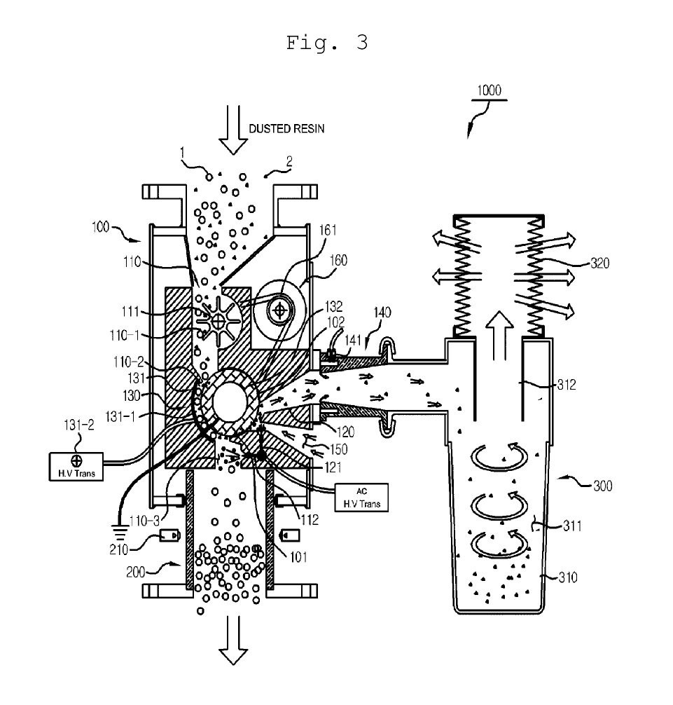

FIG. 3 is a cross-sectional view of the dust removal apparatus 1000.

Referring to FIG. 2 or FIG. 3, the main body 100 includes a transfer path 110 to separate and discharge the raw material 1 and the dust 2, introduced from the dryer 400, into the raw material storage unit 200 and the dust storage unit 300, respectively, a dust discharger 120, an adsorbing unit 130, a connection part 140, an air inlet 150, and a power unit 160.

In this regard, the transfer path 110 is divided, based on the adsorbing unit 130, into three paths: an introduction path 110-1 to introduce the raw material 1 and the dust, introduced from the dryer 400, into the adsorbing unit 130; an electrifying path 110-2 through which the raw material 1 and the dust 2 are transferred in the adsorbing unit 130; and a discharge path 110-3 through which the raw material 1 separated from the adsorbing unit 130 is discharged.

Thus, the raw material 1 and the dust 2, introduced via the introduction path 110-1, are each independently separated by the adsorbing unit 130 while moving through the electrifying path 110-2 formed on the adsorbing unit 130, and thus, the raw material 1 is discharged to the raw material storage unit 200 via the discharge path 110-3 and the dust 2 is discharged into the dust storage unit 300 via the dust discharger 120.

In this regard, the adsorbing unit 130 includes an electrifying unit 131 and a roller 132 configured to separate the raw material 1 and the dust 2, introduced via the introduction path 110-1.

That is, in the adsorbing unit 130, the roller 132 is provided at a one side of the electrifying path 110-2 and the electrifying unit 131 is provided at the other side of the electrifying path 110-2, and thus, the adsorbing unit 130 performs an electrical action to independently separate the raw material 1 and the dust 2 moving via the electrifying path 110- 2 formed between the roller 132 and the electrifying unit 131.

In particular, the electrifying unit 131 electrically charges the raw material 1 and the dust 2, introduced via the electrifying path 110-2, and the roller 132 adsorbs the raw material 1 and the dust 2, having electric charges by the electrifying unit 131, by electrical attraction.

In this regard, when a diameter of the electrifying path 110-2 formed between the roller 132 and the electrifying unit 131 becomes large, electric power needed for the electrical action occurring in the adsorbing unit 130 is increased.

That is, in order for a discharge electrode 131-1 that applies current to the raw material 1 and the dust 2 to emit high electric power according to the increase in diameter of the electrifying path 110-2, electric power needed in a high-pressure pulse generator 131-2 that supplies a high-pressure pulse to the discharge electrode 131-1 is increased.

Thus, it is recommended that the electrifying path 110-2 have as small a diameter as possible so long as the raw material 1 and the dust 2 can move therethrough.

In addition, the discharge electrode 131-1 may be spaced apart from an outer circumferential surface of the roller 132 by a certain distance to face the outer circumferential surface thereof.

In particular, by such a configuration wherein the discharge electrode 131-1 is spaced apart from the outer circumferential surface of the roller 132 by a certain distance to face the roller 132, the raw material 1 and the dust 2 moving through the electrifying path 110-2 move along the outer circumferential surface of the roller 132 and thus are smoothly adsorbed onto the roller 132.

The raw material 1 adsorbed onto the roller 132 is detached by a first inner wall 101 of the main body 100, formed between the discharge path 110-3 and the dust discharger 120.

In this regard, to detach the raw material 1 adsorbed onto the roller 132, the first inner wall 101 is spaced apart from the outer circumferential surface of the roller 132 by a shorter distance than a diameter of the raw material 1.

That is, the roller 132 rotates in a direction in which the raw material 1 and the dust 2 move through the electrifying path 110-2 and adsorbs the raw material 1 and the dust 2, and the adsorbed raw material 1 contacts the first inner wall 101 and thus is detached thereby as the roller 132 rotates.

In addition, the dust 2 adsorbed onto the roller 132 is detached by the first inner wall 101 or a first ion generator 121 provided at a predetermined position in an entrance of the dust discharger 120 into which the dust 2 detached from the roller 132 is introduced to release ions.

That is, the first ion generator 121 is provided at the first inner wall 101 or the entrance of the dust discharger 120 to release ions to the dust 2 adsorbed onto the roller 132, thereby removing the electrical charge therefrom.

Although a method of using a separation distance between the first inner wall 101 and the roller 132 and a method of using the first ion generator 121 have been described as a method of detaching the raw material 1 and the dust 2 adsorbed onto the roller 132, various other methods, in which a first protrusion through which the raw material 1 cannot pass is provided at a contact potion between the first inner wall 101 and the discharge path 110-3 to detach the raw material 1 from the roller 132, and second protrusion through which the dust 2 cannot pass is provided at the first inner wall 101 or the entrance of the dust discharger 120 to detach the dust from the roller 132, may be performed.

Thus, the method of detaching the raw material 1 and the dust 2 from the roller 132 is not particularly limited so long as it enables the raw material 1 and the dust 2 to be efficiently separated and thus transferred to the raw material storage unit 200 and the dust storage unit 300, respectively.

The raw material 1 detached from the roller 132 retains the electrical charge imparted by the electrifying unit 131, and thus may be adsorbed onto an inner wall of the raw material discharge path 110-3 or the raw material storage unit 200 by electrical attraction therebetween.

Thus, to neutralize the raw material 1, a second ion generator 112 is provided at the raw material discharge path 110-3 to release ions, thereby neutralizing the raw material 1 detached from the roller 132.

The dust discharger 120 is connected to the dust storage unit 300 via the connection part 140.

In this regard, the dust discharger 120 and the connection part 140 are inclined closer to a ground surface away from the entrance of the dust discharger 120 towards the dust storage unit 300, and thus the dust 2 detached from the roller 132 may be transferred to the dust storage unit 300 by gravity. However, in order for the dust 2 to effectively move without stopping due to friction, an air amplifier 141 may be provided at the connection part 140.

The air amplifier 141 absorbs external air and releases the absorbed air from the other side to the one side of the connection part 140.

Thus, the air amplifier 141 serves to move air remaining inside the connection part 140 to the dust storage unit 300.

In this regard, the air inlet 150 of the main body 100 is spaced apart from a lower end of the dust discharger 120 by a predetermined distance to absorb, from the outside, air for transferring the dust 2 detached from the roller 132 to the dust storage unit 300, in cooperation with the air amplifier 141.

In particular, the air inlet 150 extends from a lower end thereof to the first inner wall 101.

A relationship between the air inlet 150 and the air amplifier 141 will now be described with reference to FIG. 2. Compressed air discharged from the air amplifier 141 transfers air of the connection part 140 to the dust storage unit 300 and thus the connection part 140 temporarily forms a vacuum.

Thus, external air is introduced from the air inlet 150 connected to the connection part 140 and transferred to the connection part 140 in a vacuum state.

That is, the dust 2 detached from the roller 132 is transferred to the dust storage unit 300 by flow of air from the air amplifier 141 and the air inlet 150.

In this regard, to prevent moisture in the external air introduced from the air inlet 150 from permeating the raw material 1 when the external air contacts the raw material 1 separated from the main body 100, the roller 132 may be disposed close to the second inner wall 102 of the main body 100, formed between the introduction path 110-1 and the dust discharger 120.

In addition, although not shown in the drawings, even when the roller 132 is disposed close to the second inner wall 102, the air introduced from the air inlet 150 may be introduced into the introduction path 110-1 and the adsorbing unit 130 in a rotation direction of the roller 132 by the Coand\check{a} effect, and thus, a blocking barrier may be configured to prevent introduction of air via a space formed between the roller 132 and the second inner wall 102.

In addition, the main body 100 may further include a controller 111 at the introduction path 110-1 to control the amount of the raw material 1 including the dust 2 introduced from the dryer 400 to the adsorbing unit 130.

The controller 111 is connected to the power unit 160 disposed at an upper end of one side of the main body 100 and the roller 132 via a power transferring member 161. Various members may be used as the power unit 160, but the power unit 160 may be a motor to continuously transfer power.

In this regard, the power transferring member 161 may be various connecting elements such as a chain or belt and is not particularly limited so long as it efficiently transfers power generated from the power unit 160 to the roller 132 and the controller 111.

In addition, the motor used in the power unit 160 may be configured in singular or plural number and thus may be connected to the roller 132 and the controller 111 via the respective power transferring members 161, or the roller 132, the controller 111, and the power unit 160 may be connected to one another via one connecting member.

The raw material storage unit 200 includes a sensor 210 to adjust the amount of the raw material 1 discharged through the raw material discharge path 110-3 and stored in the raw material storage unit 200.

The sensor 210 is provided at an upper end or side surface of the raw material storage unit 200 to measure the height of the raw material 1 stored in the raw material storage unit 200.

In addition, when the raw material 1 stored in the raw material storage unit 200 reaches a certain height, the sensor 210 transmits a signal to the power unit 160 to stop operation of the power unit 160, thereby preventing the raw material 1 from being introduced into the raw material storage unit 200.

In particular, the sensor 210 stops the power unit 160 when the raw material 1 stored in the raw material storage unit 200 reaches a certain height, thereby stopping movement of the controller 111 and the roller 132 connected to the power unit 160, and restarts the power unit 160 when the height of the raw material 1 stored in the raw material storage unit 200 is less than a predetermined height.

The dust storage unit 300, in which the dust 2 introduced from the connection part 140 is stored, includes a dust container 310 connected to the connection part 140 and a dust filter 320 connected to an upper end of the dust container 310.

The dust container 310 stores the dust 2 introduced from the connection part 140.

Thus, the dust container 310 is perforated from an inner side to an upper side thereof and thus a dust storage space 311 for storage of the dust 2 is formed therein.

In addition, an outer wall of the dust container 310 is configured to have a single step or a plurality of steps and thus the area of the dust storage space 311 increases away from a lower side thereof towards an upper side thereof.

In addition, the dust container 310 is provided with a dust blocking part 312, an upper end of which is vertically bent inward and downward, and thus, to prevent air including the dust 2 discharged from the connection part 140 from moving upward while rotating from the lower side to the upper side along an inner wall of the dust container 310.

In particular, the air including the dust 2 introduced from the connection part 140 maintains moving force obtained by the air amplifier 141 and thus moves upward along the inner wall of the dust container 310.

In this regard, to weaken a force of the air including the dust 2, moving upward along the inner wall of the dust container 310, the dust container 310 increases in area away from the lower side thereof towards the upper side thereof and is provided with the dust blocking part 312 at an upper end thereof.

Thus, clogging of the dust filter 320 with the dust 2 that may occur in the dust filter 320 may be prevented by minimizing direct contact between the dust filter 320 disposed at the upper end of the dust container 310 and the dust 2.

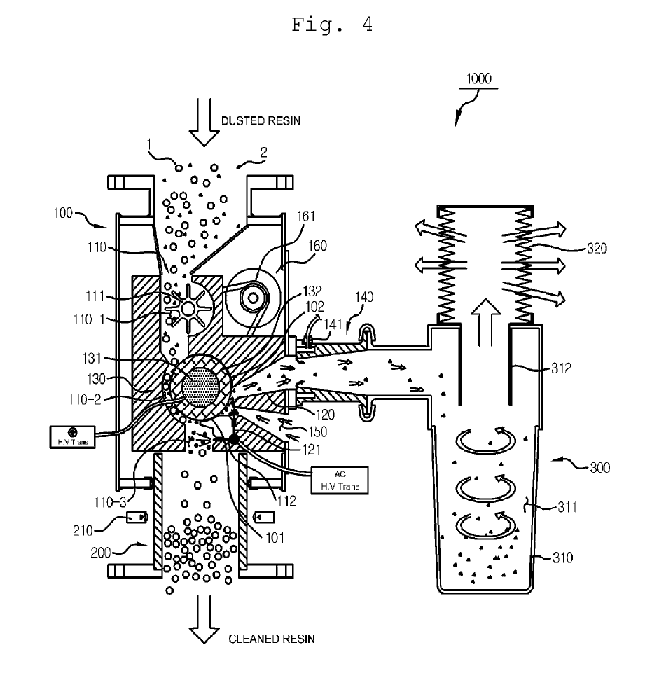

FIG. 4 is a view of a dust removal apparatus 1000 according to another embodiment of the present invention.

Referring to FIG. 4, the adsorbing unit 130 may be configured such that the electrifying unit 131 is disposed in the roller 132.

In particular, the electrifying unit 131, provided at the inner wall of the main body 100 and spaced apart from the roller 132 by a predetermined distance to electrically charge the raw material 1 and the dust 2 moving through the electrifying path 110-2, is disposed in the roller 132 so that the raw material 1 and the dust 2 moving through the electrifying path 110-2 are electrically charged.

Thus, the roller 132 and the electrifying unit 131 are configured in an integrated form, and thus, configuration of the adsorbing unit 131 is simplified and, accordingly, manufacturing processes of products may be simplified.

In addition, the electrifying unit 131 may be disposed at any position so long as it electrically charges the raw material 1 and the dust 2 for smooth adsorption onto the roller 132.

Thus, the electrifying unit 131 is provided at a transfer path through which the raw material 1 and the dust 2 move from the dryer 400 to the adsorbing unit 130 or the adsorbing unit 130, but the position thereof is not particularly limited so long as it enables the raw material 1 and the dust 2 to be smoothly adsorbed onto the roller 132.

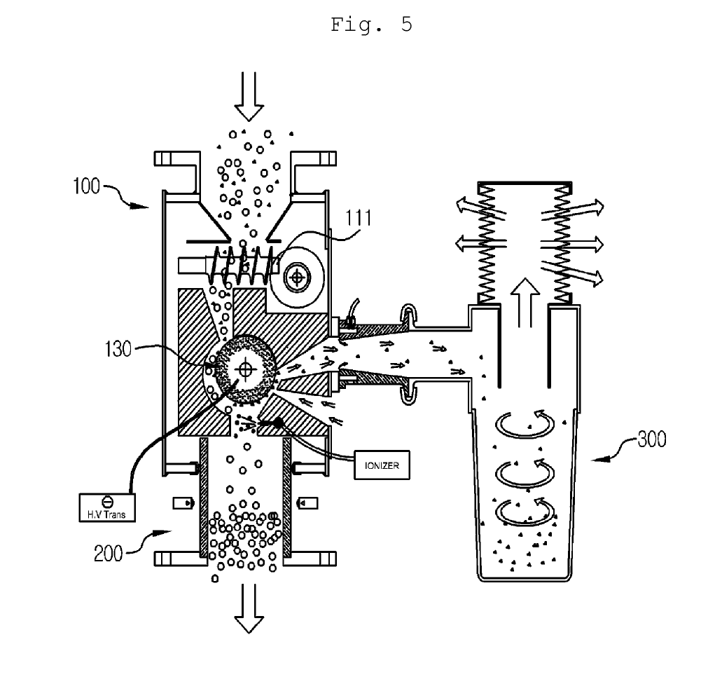

In addition, as illustrated in FIG. 5, the dust removal apparatus 1000 may be configured such that the roller 132 is grounded and inserted thereinto in a state of previously being electrically charged, or the roller 132 adsorbs the raw material 1 and the dust 2 having electric charges obtained by frictional interaction with the controller 111.

The above-described embodiments of the present invention should not be interpreted as limiting to the scope of the invention. It should be understood by those skilled in the art that the invention may be applied to various applications, and various changes and modifications may be made without departing from the spirit and scope of the invention. Thus, these changes and modifications are intended to be within the scope of the invention as long as they are obvious to those skilled in the art.

DESCRIPTION OF REFERENCE NUMERALS

| | |
|---|---|
| 1000: Dust removal apparatus | |
| 1: Raw material | |
| 2: Dust | |
| 100: Main body | |
| 101: first inner wall | |
| 102: Second inner wall | |
| 110: Transfer path | 110-1: Introduction path |
| 110-2: Electrifying path | 110-3: Discharge path |
| 111: Controller | |
| 112: Second ion generator | |
| 120: Dust discharger | 121: First ion generator |
| 130: Adsorbing unit | |
| 131: Electrifying unit | 131-1: Discharge electrode |
| 131-2: High-pressure pulse generator | |
| 132: Roller | |
| 140: Connection part | |
| 141: Air amplifier | |
| 150: Air inlet | 151: Air amplifier |
| 160: Power unit | 161: Power transferring member |
| 200: Raw material storage unit | |
| 210: Sensor | |
| 300: Dust storage unit | |
| 310: Dust container | 311: Dust storage space |
| 312: Dust blocking part | |
| 320: Dust filter | |
| 400: Dryer | |

What is claimed is:

1. A dust removal apparatus comprising:
a main body comprising a transfer path opening from an upper end to a lower end thereof;
a dust discharger extending from a one side of the transfer path to a side surface of the main body; and
an adsorbing unit disposed at a position connecting the transfer path to the dust discharger to adsorb a raw material and dust moving from the upper end to the lower end of the transfer path, wherein
the adsorbing unit comprises an electrifying unit to electrically charge the raw material and the dust, a roller to adsorb the charged raw material and the charged dust by electrical attraction while rotating, and a first ion generator to release ions to the dust adsorbed on the roller and thus detach the dust therefrom.

2. The dust removal apparatus of claim 1, wherein
the roller is surrounded by an inner wall of the main body and face the electrifying unit to form an electrifying path, the electrifying unit being configured such that a one side thereof is spaced apart from an outer circumferential surface of the roller by a distance limiting introduction of the raw material into the dust discharger and the other side thereof is spaced apart from the outer circumferential surface of the roller by a distance allowing transfer of the raw material and the dust, and the first ion generator is provided at an entrance of the dust discharger through which the dust detached from the roller is introduced into the dust discharger.

3. The dust removal apparatus of claim 1, wherein
the roller is provided with the electrifying unit at an inside thereof and is surrounded by an inner wall of the main body such that a one side thereof is spaced apart from the inner wall of the main body by a distance limiting introduction of the raw material into the dust discharger and the other side thereof is spaced apart from the inner wall of the main body by a distance allowing transfer of the raw material and the dust, thereby forming an electrifying path, and the first ion generator is provided at an entrance of the dust discharger through which the dust detached from the roller is introduced into the dust discharger.

4. The dust removal apparatus of claim 1, wherein
the dust removal apparatus comprises a raw material storage unit to store a raw material discharged from the transfer path, a dust storage unit to store dust discharged from the dust discharger, and a connection part connecting the dust discharger to the dust storage unit, wherein the connection part comprises an air amplifier to suck external air and transfer the external air to the dust storage unit.

5. The dust removal apparatus of claim 4, wherein
the main body comprises an air inlet provided at a lower end of the dust discharger and spaced apart therefrom, the air inlet connecting an outside of the main body to an entrance of the dust discharger, and the air amplifier sucks, from the outside, air for transferring the dust detached from the roller to the dust storage unit, in cooperation with the air inlet.

6. The dust removal apparatus of claim 4, wherein
the main body further comprises a controller to control an amount of the raw material, including the dust, introduced from the transfer path to the adsorbing unit.

7. The dust removal apparatus of claim 6, wherein
the main body further comprises a power unit to transfer power to the controller and the roller, the power unit comprising a power transmitting member connecting the controller and the roller to transfer power thereto.

8. The dust removal apparatus of claim 1, wherein
the electrifying unit comprises a discharge electrode to emit a large amount of electrons to resin and dust and a high-pressure pulse generator to supply a high-pressure pulse to the discharge electrode.

9. The dust removal apparatus of claim 2, wherein
the electrifying unit comprises a discharge electrode to emit a large amount of electrons to resin and dust and a high-pressure pulse generator to supply a high-pressure pulse to the discharge electrode.

10. The dust removal apparatus of claim 3, wherein
the electrifying unit comprises a discharge electrode to emit a large amount of electrons to resin and dust and a high-pressure pulse generator to supply a high-pressure pulse to the discharge electrode.

11. The dust removal apparatus of claim 1, wherein
the transfer path is provided with a second ion generator at a lower end thereof to remove an electric charge of the raw material detached from the roller.

12. The dust removal apparatus of claim 1, wherein
the roller rotates in a direction in which the raw material and the dust move through the transfer path, and the raw material adsorbed on the roller contacts an inner wall of the main body formed between a lower portion of the transfer path and the dust discharger and thus is detached thereby from the roller.

13. The dust removal apparatus of claim 1, wherein
the roller is grounded and thus adsorbs the raw material and the dust, having electrical charges, an outer circumferential surface thereof being spaced apart from an inner wall of the main body by a distance allowing transfer of the raw material and the dust.
